(19) United States
(12) Patent Application Publication
(10) Pub. No.: US 2018/0312373 A1
(43) Pub. Date: Nov. 1, 2018

(54) SECURING ELEMENT FOR A DEFLECTING UNIT

(71) Applicant: Inventio AG, Hergiswil (CH)

(72) Inventor: Christof Moser, Luzern (CH)

(21) Appl. No.: 15/770,233

(22) PCT Filed: Oct. 27, 2016
(86) PCT No.: PCT/EP2016/075985

§ 371 Date: Apr. 23, 2018

(30) Foreign Application Priority Data
Oct. 30, 2015 (EP) 15192397.6

(51) Int. Cl. B66B 15/02; B66B 9/00; B66B 5/02

(52) U.S. Cl. CPC B66B 15/02; B66B 5/02; B66B 9/00

(57) ABSTRACT

A deflecting unit for guiding and deflecting the support cable or strap of an elevator system includes a deflecting roller and an axle which is secured to a support and on which the deflecting roller is mounted in a freely rotatable manner. The axle has an axle head that is molded onto the axle and which axially secures the axle on one side. In order to support the axle so as to secure against rotation, a securing element that is made of a quadrangular plate and which is screwed onto the support is provided, the securing element being supported on an anti-rotation portion arranged on the axle head. The securing element has an inner annular fixing region that is connected to the outer holding region by radially running webs designed as predetermined breaking points.

### FIELD

The invention relates to an elevator system with a car, a counterweight and a support means supporting the car and the counterweight, wherein at least one of the car and the counterweight is connected via at least one deflecting unit to the support means.

### BACKGROUND

Elevator systems are usually installed in a shaft of a building and are used for trans-porting people or goods. The car mobile in the vertical direction in the shaft is carried by means of support means, for example in the form of cables or straps, wherein the support means are connected to a drive for moving the car. Depending on the design of the elevator system, the car and/or a counterweight connected to the car via the support means is connected to the support means via one or more deflecting units. In the case of a 2:1 suspension, one or two deflecting units are assigned for example to the car and one deflecting unit to the counterweight.

Deflecting units comprise one or more deflecting rollers, which is or are mounted freely rotatable for example by the use of roller bearings. The axle is fastened to a support, on which the car or the counterweight is hung or suspended. This fastening of the axle can lead to problems with the known deflecting units for elevator systems. In rare cases, it may happen, for example due to a lack of or neglected maintenance, that the deflecting roller can no longer rotate freely with respect to the axle, as a result of which high torques between the deflecting roller and the axle can arise. This can have an adverse effect on the fastening of the axle. In extreme cases, the axle may drift away from the support, which can lead to accidents.

In order to prevent such accidents, deflecting units with a deflecting roller and an axle fastened to a support have been developed, wherein an anti-rotation bearing of the axle in the support is ensured in a first life cycle and wherein, when a specific torque is exceeded, the axle is mounted rotatably in the support in the second life cycle. A comparable generic elevator system with a deflecting unit assigned to the counterweight, which has the described function with two life cycles, has become known from WO 2013/186092 A1.

### SUMMARY

It is the problem of the present invention to provide an elevator system, with which the operational safety can be further increased.

According to the invention, this problem is solved with an elevator system as described below since the holding means for the axial securing of the axle on the support, at least for special operational states (for example after the system has been inadequately maintained or not maintained and consequently the deflecting rollers suddenly and unexpectedly can no longer rotate completely freely), enable a rotation of the axle in the support [is possible], the risk of operational malfunctions or accidents can be reduced considerably compared to elevator systems with conventional deflecting units. With this arrangement, it is ensured that an unintended escape of the axle out of the support as a result of drifting away axially in the case of excessive mechanical load can be virtually eliminated. The axle arrangement and fastening is used particularly advantageously in the deflecting unit assigned to the counterweight. At least one of the holding means is fixed non-rotatably with respect to the support by an anti-rotation means for an anti-rotation bearing of the axle in a first life cycle. With such an arrangement, the respective deflecting unit can be operated in the optimum manner at least in the first life cycle. For example, the deflecting roller can be rotated with a lower level of noise and with little wear.

At least one deflecting unit is constituted such that, when a specific torque between the deflecting roller and the axle is exceeded, the anti-rotation means releases the corresponding holding means (or the holding means assigned to the anti-rotation means) and the axle is mounted rotatable in the support between the holding means in a second life cycle. The lifetime of the fastening of the axle of the deflection unit is thus characterized by two life cycles. In the first life cycle, which more or less corresponds to a normal state, the axle cannot rotate in the support. In the subsequent second life cycle, which more or less corresponds to an emergency operational state, the axle can rotate in the support, wherein the axial securing of the axle in the support continues to be ensured. By splitting the lifetime into two cycles, the deflecting unit can also be monitored better. It may happen in the second life cycle that the axle to some extent eats into the support due to wear and a more or less vertically running longitudinal hole arises in the support. This phenomenon can easily be observed, as a result of which the monitoring of the deflecting unit is simplified for the maintenance personnel.

Due to the fact that the anti-rotation means comprises or comprise a securing element fastened to the support and comprising a weakening zone created for example by material selection or shaping, wherein the securing element acts on the axle in a locking position for the anti-rotation bearing of the axle in the first life cycle and wherein the securing element is constituted such that, under the force effect when a specific torque is exceeded, the locking position of the axle to provide for the anti-rotation of the axle with respect to the support is removed due to deformation (e.g. due to plastic deformation) and/or destruction of the weakening zone in the second life cycle, a particularly advantageous reliable deflecting unit is created.

The securing element can be a body preferably formed by a plate, which can be fastened to the support by a screw or in some other way.

The securing element is preferably constituted and fastened to the support in such a way that the securing element remains on the support after the locking position has been removed, under the force effect when a specific torque is exceeded, with respect to the rotatable bearing of the axle in the support in the second life cycle. It is thus possible to prevent parts flying away from causing damage.

The weakening zone of the securing element can be constituted as a predetermined breaking point or can contain a predetermined breaking point.

At least one web can preferably be integrated in the securing element for the formation of the weakening zone. This web or at least one of the webs can particularly preferably be constituted as a predetermined breaking point.

The securing element can comprise a fixing region, by means of which the securing element is or can be fastened to the support, and a holding region, by means of which the axle is or can be held by the securing element in the locking position in the first life cycle. The weakening zone can connect the fixing region to the holding region. The weakening zone is thus located between the fixing region and the holding region.

The securing element is can comprise a fixing region, by means of which the securing element is or can be fastened to the support, and a holding region, by means of which the axle is or can be held by the securing element in the locking position in the first life cycle, wherein the fixing region and the holding region are connected by the at least one web. The securing element is preferably constituted as a monolithic body.

The fixing region can have the shape of a ring. When use is made of screws for the fastening of the securing element to the support, the annular fixing region forms an active surface, which is or can be acted upon in a clamping manner by the screw head or a screw nut.

It is advantageous if the securing element comprises at least two webs. Two webs are particularly preferably provided. In this embodiment, it can be ensured for example that the securing element also remains on the support after the locking position of the axle has been removed in the second life cycle, since only one of the two webs breaks or is severed when the predefined torque is exceeded, whereas the other web, whilst experiencing a plastic deformation, otherwise remains intact. The securing element can however also comprise more than two webs for special applications. The securing element with the plurality of webs can have a star-shaped arrangement of the webs.

The inner, annular fixing region can be connected to the outer holding region by radially and preferably linearly running webs. A star-shaped arrangement can thus ensue. Other web geometries are however also conceivable. Thus, the webs could have a serpentine or zigzag course. A spiral shape is also conceivable, wherein in this case one web or two webs to form a double spiral would be provided.

The webs can have a constant web width over the entire length of the web. It may however be advantageous if the webs are constituted tapering radially inwards at a least with regard to a plan view. For example, the respective web can have a trapezoidal shape.

It may also be advantageous if the holding region has an essentially rectangular outer contour. The securing element could easily be produced from a rectangular metal plate. Such a securing element could thus also be referred to as a “breakplate”.

The holding means can be formed on one side by an axle head molded on the axle to form a shoulder-like stop. The axle with the axle head is preferably constituted monolithic and is made for example from a metallic material. The axle can be an essentially rotation-symmetrical axle body made of steel. In this variant of embodiment, the axle thus has a mushroom-shaped configuration, wherein the axle forms the aforementioned axle head (“mushroom umbrella”), which is followed by an axle stem in the axial direction. The axle head is constituted essentially cylindrical and has a greater diameter than the axle stem. A holding means thus connected rigidly to the axle leads to particularly great stability of the axle fastening. The axle head can easily be dimensioned such that breaking-off or other destruction of the axle head is virtually impossible even with extraordinarily high mechanical loads during the operation of the elevator. The axle arrangement with the mushroom-shaped axle body, moreover, is easy to handle and enables simple and rapid assembly and dismantling.

The anti-rotation bearing of the axle can be achieved by the fact that at least one of the holding means, such as for example the aforementioned axle head, comprises an anti-rotation portion preferably defined by a flat surface, which rests on a securing element fastened to the support. The anti-rotation portion can be arranged in the peripheral region of the axle head. If the axle head has for example a cylindrical external shape, the anti-rotation portion can be formed by in a straightforward manner by chamfering the cylindrical circumferential surface. Instead of an anti-rotation portion created by chamfering, the axle head can also comprise an anti-rotation portion extending in the radial direction, which is fastened to the support for example by means of a screw connection.

It may also be advantageous if the holding means is formed by a separate component on at least one side. It is particularly advantageous if the holding means is formed by the previously described axle head on one side of the axle and the holding means is formed by the separate component on the opposite side. Straightforward assembly and dismantling of the deflecting unit is thus ensured.

### DESCRIPTION OF THE DRAWINGS

Further individual features and advantages of the invention emerge from the following description of an example of embodiment and from the drawings. In the figures:

FIG. 1 shows a simplified representation of an elevator system in a side view,

FIG. 2 shows a detail of a cross-section through a deflecting unit of the elevator system according to FIG. 1,

FIG. 3 shows a perspective view of a side of the deflecting unit from FIG. 2 in a partially exploded representation,

FIG. 4 shows another side of the deflecting unit from FIG. 2,

FIG. 5 shows a perspective exploded representation of the axle arrangement for the deflecting unit according to FIG. 2,

FIG. 6 shows a securing element for the anti-rotation bearing of the axle of the deflecting unit according to FIG. 2, and

FIG. 7 shows the securing element from FIG. 6 after the force effect when the specific torque is exceeded between the deflecting roller and the axle of the deflecting unit.

### DETAILED DESCRIPTION

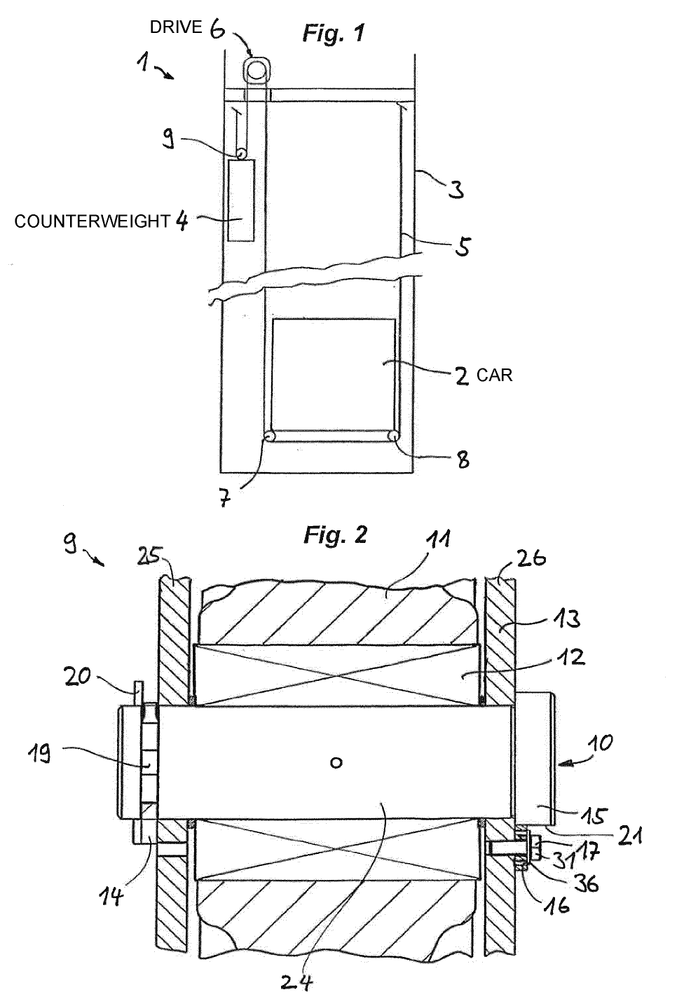

FIG. 1 shows an elevator system designated as a whole by 1 in a very simplified and schematic representation. The elevator system (or elevator in short) 1 comprises a car 2 mobile vertically up and down in an elevator shaft 3 for transporting people or goods. Support means 5 for supporting car 2 and a counterweight 4 can be a cable or a plurality of cables. Other support means for example in the form of straps are of course also conceivable. Car 2 and counterweight 4 are connected to support means 5 via deflecting units 7, 8, 9. In order to move car 2 and counterweight 4, a drive 6 is used, for example a driving pulley drive, which is arranged for example in a separate machine room in the region of the shaft head. The special deflecting units described in greater detail below would of course also be suitable for other elevators and in particular also for so-called machine-room-less elevators. Elevator system 1 represented in FIG. 1 is designed in a 2:1 suspension configuration. However, other suspension variants (e.g. 4:1) would of course also be conceivable. Furthermore, instead of the underlooping of car 2 shown in FIG. 1, a deflecting unit could also be arranged in the region of the car roof.

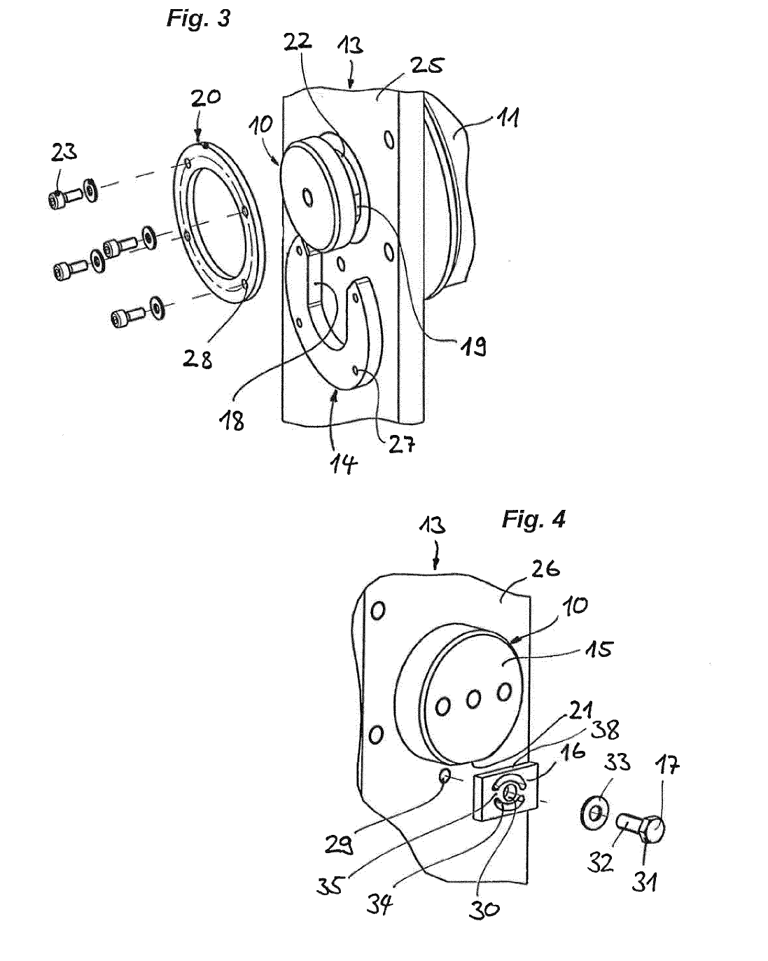

Technical details concerning the structure of a deflecting unit can be seen in FIG. 2 and in FIGS. 3 to 5. FIG. 2 shows the region of the rotary axle of deflecting unit 9 assigned to the counterweight, on which the counterweight (not represented here) is suspended by means of support 13. Deflecting unit 9 represented here, however, could also be assigned to car 2 (7, 8; see FIG. 1) or even arranged at another location in elevator system 1. Deflecting unit 9 comprises a deflecting roller 11, at the periphery whereof the support means (not represented here) is guided and deflected. Deflecting roller 11 is connected via bearing 12 to an axle 10 and is mounted freely rotatable on axle 10. Depending on the requirement, bearing 12 can for example contain one or more roller bearings. Axle 10 is fastened to support 13. Support 13 is connected to the counterweight (not represented). Support 13 comprises two walls 25 and 26 lying opposite one another, which are each provided with a bearing mount, through which axle 10 is passed. Axle 10 is secured on both sides in the axial direction. On one side, the holding means for the axial securing of the axle on support 13 is formed by an axle head 15 molded on axle 10, which defines a shoulder-like stop. On the opposite side, the axial securing is achieved by a holding part 14 fitted to the axle. The securing part denoted by 20 serves to secure holding part 14 in the position shown.

Axle 10 is connected non-rotatably to supports 13, wherein the anti-rotation lock engages solely on one side of the axle. This anti-rotation lock is secured by the securing element denoted by 16, which is screwed onto support 13. Axle head 15 comprises an anti-rotation portion 21 defined by a flat surface, which rests on securing element 16. Securing element 16 is fastened to support 13 by means of a screw connection.

Amongst other things, it emerges from FIG. 3 that holding part 14 is designed in the shape of a horseshoe. Horseshoe-shaped holding part 14 comprises parallel flanks 18 lying opposite one another, which cooperate with complementary form-fit portions 19 and thus ensure a non-rotatable fixing of holding part 14 in the ready-assembled position. In the inserted position, holding part 14 surrounds axle 10 in respect of the radial direction defined by the axle. Holding part 14 is provided with receiving points for fastening screws 23, said receiving points being constituted as threaded bores. Securing part 20 is designed annular and contains four through-holes 28 corresponding to threaded bores 27, through which through-holes screws 23 can be introduced.

As FIG. 4 shows, securing element 16 is formed by a plate-like body. Instead of the rectangular plate represented in plan view, other shapes could also be selected for component 16. It should be noted that securing element 16, on the side denoted by 38, comprises an edge or portion which cooperates with anti-rotation portion 21 of axle 10 and is supported on the latter. Securing element 16 comprises a hole 30, through which screw 17 can be introduced and then screwed into the threaded bore 29 in wall 26 of support 13. The essentially cylindrically constituted axle head comprises an anti-rotation portion 21 created by chamfering. Anti-rotation portion 21 is supported on securing element 16 and thus produces the anti-rotation locking of axle 10. Securing element 16 is located in a locking position in FIG. 4. Fastening screw 17 has a screw head 31 and a following screw shank 32 provided with a thread. Furthermore, a washer 33 can be seen, which lies on an annular fixing region 34 of securing element 16 after fastening screw 17 has been tightened up. Annular fixing region 34 thus forms an active surface, which can be acted upon in a clamping manner by screw head 31. It is of course conceivable to constitute the screw connection such that washer 33 can be dispensed with.

If, under the effect of excessively high shearing forces, for example when deflecting roller 11 suddenly and unexpectedly can no longer rotate and a specific torque between deflecting roller 11 and axle 10 is exceeded, securing element 16 is compressed. During this compression, upper side of securing element 16 denoted by 38 and facing anti-rotation portion 21 is permanently pushed down, as result of which the locking position is removed. Securing element 16 is then plastically deformed and partially destroyed (see following FIG. 7).

Securing element 16 comprises for this special purpose two webs 35 constituted as predetermined breaking points. With regard to details concerning the precise embodiment of securing element 16, reference is made to FIGS. 6 and 7. The mentioned torque can be adjusted precisely by material selection, dimensioning and by shaping, in particular the web geometries, of securing element 16. Screw 17 remains intact even with extremely high mechanical impact, as a result of which securing element 16 together with screw 17 remains in any event on support 13. As can be seen, screw 17 thus does not represent a predetermined breaking point.

Thanks to the two lateral holding means, i.e. axle head 15 on the one side and holding part 14 accommodated in a groove 22 of axle 10 on the other side, axle 10 continues to be secured in the axial direction against undesired movement. If the maintenance personnel discover axle 10 rotating in support 13, they can take repair and maintenance measures. After the release of the anti-rotation device, axle 10 is thus mounted rotatably in support 13 in a second life cycle of the deflecting unit. Tests have shown that rotating axle 10 after some time can as it were eat into support 13 due to wear and a more on less vertically running longitudinal hole arises in the support. Thanks to the special axle arrangement, however, axial securing is at all times ensured, so that axle 10 cannot fall out of support 13 or drift away. The longitudinal hole that may arise also permits easy monitoring of the deflecting unit.

Instead of anti-rotation portion 21 produced by chamfering and shown in FIG. 4, axle head 15 could also comprise an anti-rotation portion extending away in the radial direction or a special shaping in the peripheral region. Also, it would even be conceivable to weld the plate body of securing element 16 to axle head 15.

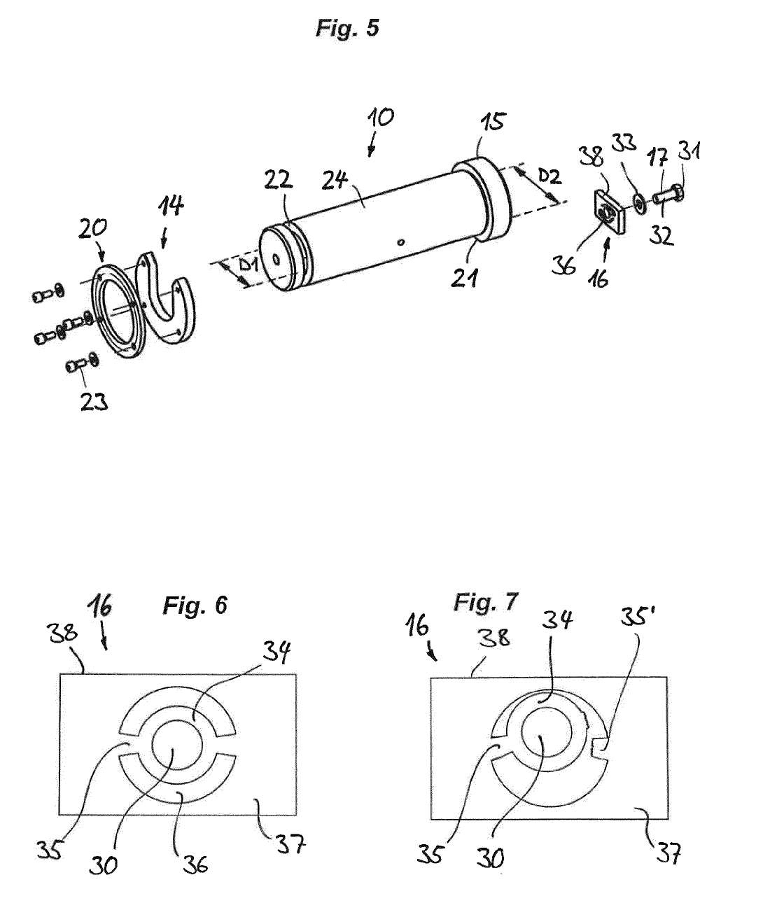

FIG. 5 shows the individual components of the axle arrangement containing axle 10 with axle head 15 molded on the axle, securing element 16 constituted as a plate, holding part 14 and securing part 20. As can be seen, axle 10 is constituted mushroom-shaped, wherein axle head 15 forms the “mushroom umbrella”. Axle stem 24 following the axle head in the axial direction has, compared to diameter D2 of axle head 15, a smaller diameter D1. Axle stem 24 can be fitted into corresponding bearing mounts of the support.

FIG. 6 shows a plan view of a securing element 16 in the original state. In this form, securing element 16 is incorporated in the respective deflecting unit and provides for the previously described anti-rotation locking of axle 10. Securing element 16 comprises two webs 35 created by arc-shaped recesses 36. Recesses 36 and through-hole 30 in the form of a bore can easily be produced for example by machining processes. A solid, rectangular metal plate (e.g. made of steel) could be used as a blank for securing element 16.

Securing element 16 comprises an inner, annular fixing region 34 and an outer holding region 37 with a rectangular outer contour. Inner, annular fixing region 34 is connected via the two webs 35 to outer holding region 37. Annular fixing region 34 serves to fasten securing element 16 to support 13 (not represented here) of the deflecting unit. Annular fixing region 34 thereby forms an active surface which can be acted upon in a clamping manner by the screw head (31) of the fastening screw (17) (see FIG. 4). The axle (also not represented here) is held by holding region 37 in the locking position for an anti-rotation bearing of the axle in the first life cycle. Webs 35 run, proceeding from annular fixing region 34, in the radial direction outwards to outer holding region 37. Webs 35 are constituted, in plan view, tapering radially inwards, wherein they are formed like a trapezium.

Under the force effect when the predefined torque of the axle is exceeded, securing element 16 is changed as follows: Side 38 of securing element 16 is pushed downwards by the rotating axle and brings about a deformation or partial destruction of securing element 16. A securing element 16 changed in this way is shown in FIG. 7. As can be seen, when side 38 is pushed down, one of the webs has been broken; whereas the other web 35, although it was plastically deformed, otherwise remains intact. A remaining web of the broken web is denoted by 35′. Securing element 16 formed from a rectangular metal plate could therefore also be referred to as a “breakplate”. Thanks to left-hand web 35 shown by way of example in FIG. 7, which in contrast with the other web does not experience any severing, it can be ensured that securing element 16 remains on support 13. FIG. 7 relates to the second life cycle, in which axle 10 is mounted rotatably in support 13.

In contrast with the example of embodiment according to FIG. 6, the securing element according to the invention could also comprise only one web or more than two webs. In the case of a securing element comprising more than two webs, the webs would preferably be arranged in a star shape. To specify a defined predetermined breaking point, an indentation, a narrow point or at all events a perforation line can be arranged in the respective web.

As an alternative to the webs, the securing element could also comprise other weakening zones, which can be deformed and/or destroyed in order to remove the locking position of the axle in respect to the desired second life cycle. The weakening zone could be formed for example by a plastically deformable material, for example a crumpling plastic material, which becomes plastically deformed in the presence of an excessive force effect.

In accordance with the provisions of the patent statutes, the present invention has been described in what is considered to represent its preferred embodiment. However, it should be noted that the invention can be practiced otherwise than as specifically illustrated and described without departing from its spirit or scope.

1-16. (canceled)

17. An elevator system with a car, a counterweight and a support means for supporting the car and the counterweight, wherein at least one of the car and the counterweight is connected by at least one deflecting unit to the support means, the at least one deflecting unit comprising:
at least one deflecting roller;
an axle on which the at least one deflecting roller is mounted freely rotatably;
a support to which the axle is fastened;
wherein the axle includes holding means on both sides of the axle between which holding means the support is accommodated and which holding means permit a rotation of the axle with respect to the support;
wherein at least one of the holding means is fixed non-rotatably by an anti-rotation means for an anti-rotation bearing of the axle in a first life cycle;
wherein when a specific torque applied between the deflecting roller and the axle is exceeded, the anti-rotation means release the holding means and the axle is then mounted rotatably in the support in a second life cycle;
wherein the anti-rotation means includes a securing element fastened to the support, the securing element having a weakening zone; and
wherein the securing element acts on the axle in a locking position for the anti-rotation bearing of the axle in the first life cycle and under a force effect when the specific torque is exceeded, the locking position of the axle is removed due to at least one of deformation and destruction of the weakening zone in the second life cycle.

18. The elevator system according to claim 17 wherein the securing element has a body formed as a plate.

19. The elevator system according to claim 17 wherein the securing element is fastened to the support by a screw.

20. The elevator system according to claim 17 wherein the securing element is fastened to the support in the first life cycle and remains on the support after the locking position has been removed in the second life cycle.

21. The elevator system according to claim 17 wherein the weakening zone of the securing element is formed as a predetermined breaking point or contains a predetermined breaking point.

22. The elevator system according to claim 17 wherein at least one web is integrated in the securing element.

23. The elevator system according to claim 22 wherein the at least one web is formed as a predetermined breaking point.

24. The elevator system according to claim 17 wherein the securing element includes a fixing region by which the securing element is fastened to the support, and a holding region by which the axle is held by the securing element in the locking position in the first life cycle, and the weakening zone connects the fixing region to the holding region.

25. The elevator system according to claim 24 wherein the fixing region is formed in a ring shape.

26. The elevator system according to claim 24 wherein the fixing region is an inner, annular fixing region and the holding region surrounds the fixing region.

27. The elevator system according to claim 17 wherein the securing element includes a fixing region by which the securing element is fastened to the support, and a holding region by which the axle is held by the securing element in the locking position in the first life cycle, wherein the fixing region and the holding region are connected by at least one web.

28. The elevator system according to claim 27 wherein the fixing region is formed in a ring shape.

29. The elevator system according to claim 27 wherein the fixing region is an inner, annular fixing region and the holding region surrounds the fixing region.

30. The elevator system according to claim 29 wherein the securing element includes two webs connecting the fixing region to the holding region.

31. The elevator system according to claim 30 wherein the webs extend radially from the inner, annular fixing region to the holding region.

32. The elevator system according to claim 31 wherein the webs taper radially inwardly toward the inner, annular fixing region.

33. The elevator system according to claim 27 wherein the holding region is formed with a rectangular outer contour.

34. The elevator system according to claim 17 wherein the at least one holding means that is fixed non-rotatably includes an anti-rotation portion formed as a flat surface that rests on the securing element fastened to the support.
